(19) United States
(12) Patent Application Publication
(10) Pub. No.: US 2024/0275774 A1
(43) Pub. Date: Aug. 15, 2024

(54) INTER-MESSAGE CERTIFICATE AND DIGEST ARRANGEMENTS IN WIRELESS COMMUNICATIONS SYSTEMS

(71) Applicant: QUALCOMM Incorporated, San Diego, CA (US)

(72) Inventors: Yue YIN, Beijing (CN); Shuping CHEN, Beijing (CN); Lu GAO, Beijing (CN); Yan LI, Beijing (CN)

(21) Appl. No.: 18/292,734

(22) PCT Filed: Sep. 17, 2021
(86) PCT No.: PCT/CN2021/118942

§ 371 Date: Jan. 26, 2024

(51) Int. Cl. H04L 9/40

(52) U.S. Cl. CPC H04L 63/0823

(57) ABSTRACT

Methods, systems, and devices for wireless communications are described. Aspects of the present disclosure provide techniques for inter-message certificate and digest arrangements in wireless communications systems. A first wireless device may transmit a message with a certificate, where subsequent messages include digests that correspond to the certificate. Digests may have a smaller data size than the certificate. A second wireless device may use a digest to identify a corresponding certificate transmitted in the message, and the second wireless device may use the certificate to verify that the first wireless device is the authorized transmitter of each message. In some examples, the message with the certificate may be an anchor message. In some examples, the message with the certificate may be an earliest message after an expiration or restart of a timer.

### CROSS REFERENCE

The present Application is a 371 national stage filing of International PCT Application No. PCT/CN2021/118942 by YIN et al. entitled “INTER-MESSAGE CERTIFICATE AND DIGEST ARRANGEMENTS IN WIRELESS COMMUNICATIONS SYSTEMS,” filed Sep. 17, 2021, which is assigned to the assignee hereof, and which is expressly incorporated by reference in its entirety herein.

### FIELD OF TECHNOLOGY

The following relates to wireless communications, including inter-message certificate and digest arrangements in wireless communications systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE). Some wireless communications systems may support cryptographic techniques for secure communications. However, in some cases such techniques may result in relatively high signaling overhead, poor resource utilization, or both.

### SUMMARY

The described techniques relate to improved methods, systems, devices, and apparatuses that support inter-message certificate and digest arrangements in wireless communications systems. Generally, the described techniques may enable devices to use certificates and digests across messages and message types in accordance with such inter-message certificate and digest arrangements. For example, a first wireless device may transmit a message including a certificate and subsequent messages including digests that correspond to the certificate. Digests may have a smaller payload size than a certificate (e.g., a digest may be a hash of the certificate). A receiving device may use a digest to identify the corresponding certificate. The receiving device may use the certificate to verify that the first wireless device is the authorized transmitter of each message. By communicating a message having a first message type to indicate a certificate, and then communicating one or more further messages having the same or different message type with a digest corresponding to the certificate, the system may realize improved communications efficiency, for example, while maintaining secure communications.

A method for wireless communication at a first wireless device is described. The method may include generating, by the first wireless device, a certificate for authentication of a set of messages and a digest corresponding to the certificate, transmitting a first message of the set of messages to a second wireless device, the first message having a first message type and including the certificate, and transmitting a second message of the set of messages to the second wireless device, the second message having a second message type different than the first message type, where the second message includes the digest corresponding to the certificate of the first message.

An apparatus for wireless communication at a first wireless device is described. The apparatus may include a processor, memory coupled with the processor, and instructions stored in the memory. The instructions may be executable by the processor to cause the apparatus to generate, by the first wireless device, a certificate for authentication of a set of messages and a digest corresponding to the certificate, transmit a first message of the set of messages to a second wireless device, the first message having a first message type and including the certificate, and transmit a second message of the set of messages to the second wireless device, the second message having a second message type different than the first message type, where the second message includes the digest corresponding to the certificate of the first message.

Another apparatus for wireless communication at a first wireless device is described. The apparatus may include means for generating, by the first wireless device, a certificate for authentication of a set of messages and a digest corresponding to the certificate, means for transmitting a first message of the set of messages to a second wireless device, the first message having a first message type and including the certificate, and means for transmitting a second message of the set of messages to the second wireless device, the second message having a second message type different than the first message type, where the second message includes the digest corresponding to the certificate of the first message.

A non-transitory computer-readable medium storing code for wireless communication at a first wireless device is described. The code may include instructions executable by a processor to generate, by the first wireless device, a certificate for authentication of a set of messages and a digest corresponding to the certificate, transmit a first message of the set of messages to a second wireless device, the first message having a first message type and including the certificate, and transmit a second message of the set of messages to the second wireless device, the second message having a second message type different than the first message type, where the second message includes the digest corresponding to the certificate of the first message.

Some examples of the method, apparatuses, and non-transitory computer-readable medium described herein may further include operations, features, means, or instructions for identifying the first message as an anchor message of the set of messages based on a configuration of the first wireless device indicating that the anchor message corresponds to the first message type, where transmitting the first message including the certification may be based on the identifying.

Some examples of the method, apparatuses, and non-transitory computer-readable medium described herein may further include operations, features, means, or instructions for generating, subsequent to communicating the set of messages, a second certificate for authentication of a second set of messages and a second digest corresponding to the second certificate, transmitting a third message as a second anchor message of the second set of messages based on the third message having the first message type, the third message including the second certificate, and transmitting a fourth message of the second set of messages, the fourth message including the second digest corresponding to the second certificate.

Some examples of the method, apparatuses, and non-transitory computer-readable medium described herein may further include operations, features, means, or instructions for initiating a timer associated with a duration that the certification, the digest, or both may be valid, where transmitting the first message including the certificate may be based on initiating the timer.

In some examples of the method, apparatuses, and non-transitory computer-readable medium described herein, the first message may be an earliest message of the set of messages subsequent to initiating the timer.

Some examples of the method, apparatuses, and non-transitory computer-readable medium described herein may further include operations, features, means, or instructions for generating a second certificate for authentication of a second set of messages and a second digest corresponding to the second certificate based on restarting the timer, transmitting a third message of the second set of messages, the third message including the second certificate based on the third message being an earliest message of the second set of messages, where the third message includes the first message type or the second message type, and transmitting a fourth message including the second digest corresponding to the second certificate.

Some examples of the method, apparatuses, and non-transitory computer-readable medium described herein may further include operations, features, means, or instructions for transmitting a third message having a third message type to the second wireless device, the third message including the digest corresponding to the certificate of the first message having the first message type.

Some examples of the method, apparatuses, and non-transitory computer-readable medium described herein may further include operations, features, means, or instructions for transmitting an indication of an identifier of the first wireless device to at least the second wireless device, where transmitting the first message, the second message, or both may be based on the indication of the identifier.

Some examples of the method, apparatuses, and non-transitory computer-readable medium described herein may further include operations, features, means, or instructions for updating an identifier of the first wireless device based on an expiration of a timer associated with a duration that the identifier may be valid and transmitting a third message including a second certificate based on updating the identifier.

In some examples of the method, apparatuses, and non-transitory computer-readable medium described herein, and the method, apparatuses, and non-transitory computer-readable medium may include further operations, features, means, or instructions for transmitting, in a duration between updating the identifier and transmitting the third message, one or more messages having different message types than the first message type associated with the anchor message, each of the one or more messages including the second certificate and transmitting a fourth message subsequent to the third message, the fourth message including a second digest corresponding to the second certificate.

Some examples of the method, apparatuses, and non-transitory computer-readable medium described herein may further include operations, features, means, or instructions for restarting a timer associated with a duration that the certification, the digest, or both may be valid based on updating the identifier, where transmitting the third message may be based on restarting the timer.

In some examples of the method, apparatuses, and non-transitory computer-readable medium described herein, the third message includes an earliest message of a second set of messages associated with the second certificate, the third message having the first message type or the second message type.

In some examples of the method, apparatuses, and non-transitory computer-readable medium described herein, the certificate may have a first data size larger than a second data size of the digest.

In some examples of the method, apparatuses, and non-transitory computer-readable medium described herein, the digest includes a hash of the certificate.

In some examples of the method, apparatuses, and non-transitory computer-readable medium described herein, the certificate may be associated with a set of multiple message types including the first message type and the second message type.

A method for wireless communication at a second wireless device is described. The method may include receiving a first message of a set of messages from a first wireless device, the first message having a first message type and including a certification for authentication of the set of messages, receiving a second message of the set of messages from the first wireless device, the second message having a second message type different than the first message type, where the second message includes a digest corresponding to the certificate of the first message having the first message type, and authenticating the identity of the first wireless device as the transmitter of the set of messages based on the digest and the certificate.

An apparatus for wireless communication at a second wireless device is described. The apparatus may include a processor, memory coupled with the processor, and instructions stored in the memory. The instructions may be executable by the processor to cause the apparatus to receive a first message of a set of messages from a first wireless device, the first message having a first message type and including a certification for authentication of the set of messages, receive a second message of the set of messages from the first wireless device, the second message having a second message type different than the first message type, where the second message includes a digest corresponding to the certificate of the first message having the first message type, and authenticate the identity of the first wireless device as the transmitter of the set of messages based on the digest and the certificate.

Another apparatus for wireless communication at a second wireless device is described. The apparatus may include means for receiving a first message of a set of messages from a first wireless device, the first message having a first message type and including a certification for authentication of the set of messages, means for receiving a second message of the set of messages from the first wireless device, the second message having a second message type different than the first message type, where the second message includes a digest corresponding to the certificate of the first message having the first message type, and means for authenticating the identity of the first wireless device as the transmitter of the set of messages based on the digest and the certificate.

A non-transitory computer-readable medium storing code for wireless communication at a second wireless device is described. The code may include instructions executable by a processor to receive a first message of a set of messages from a first wireless device, the first message having a first message type and including a certification for authentication of the set of messages, receive a second message of the set of messages from the first wireless device, the second message having a second message type different than the first message type, where the second message includes a digest corresponding to the certificate of the first message having the first message type, and authenticate the identity of the first wireless device as the transmitter of the set of messages based on the digest and the certificate.

In some examples of the method, apparatuses, and non-transitory computer-readable medium described herein, authenticating the identity of the first wireless device may include operations, features, means, or instructions for buffering the certificate in a memory of the second wireless device based on receiving the first message and linking the digest of the second message to the certificate of the first message.

Some examples of the method, apparatuses, and non-transitory computer-readable medium described herein may further include operations, features, means, or instructions for receiving a third message having a third message type from the first wireless device, the third message including the digest corresponding to the certificate of the first message having the first message type and authenticating the first wireless device as the transmitter of the third message based on the digest of the third message and the certificate of the first message.

Some examples of the method, apparatuses, and non-transitory computer-readable medium described herein may further include operations, features, means, or instructions for receiving a third message including a second certificate for authentication of a second set of message, the third message having any message type of a set of multiple message types, receiving a fourth message including a second digest corresponding to the second certificate, the fourth message having any message type of the set of multiple message types, and authenticating the identity of the first wireless device as the transmitter of the third message and the fourth message based on the second certificate and the second digest.

Some examples of the method, apparatuses, and non-transitory computer-readable medium described herein may further include operations, features, means, or instructions for receiving an indication of an identifier of the first wireless device, where authenticating the identity of the first wireless device as the transmitter of the set of messages may be based on the indication of the identifier.

In some examples of the method, apparatuses, and non-transitory computer-readable medium described herein, the certificate may have a first data size larger than a second data size of the digest.

In some examples of the method, apparatuses, and non-transitory computer-readable medium described herein, the digest includes a hash of the certificate.

In some examples of the method, apparatuses, and non-transitory computer-readable medium described herein, the certificate may be associated with a set of multiple message types including the first message type and the second message type.

### BRIEF DESCRIPTION OF THE DRAWINGS

FIG. 1 illustrates an example of a wireless communications system that supports inter-message certificate and digest arrangements in wireless communications systems in accordance with aspects of the present disclosure.

FIG. 2 illustrates an example of a wireless communications system that supports inter-message certificate and digest arrangements in wireless communications systems in accordance with aspects of the present disclosure.

FIGS. 3-5 illustrate examples of transmission timelines that support inter-message certificate and digest arrangements in wireless communications systems in accordance with aspects of the present disclosure.

FIG. 6 illustrates an example of a process flow that supports inter-message certificate and digest arrangements in wireless communications systems in accordance with aspects of the present disclosure.

FIGS. 7 and 8 show block diagrams of devices that support inter-message certificate and digest arrangements in wireless communications systems in accordance with aspects of the present disclosure.

FIG. 9 shows a block diagram of a communications manager that supports inter-message certificate and digest arrangements in wireless communications systems in accordance with aspects of the present disclosure.

FIG. 10 shows a diagram of a system including a device that supports inter-message certificate and digest arrangements in wireless communications systems in accordance with aspects of the present disclosure.

FIGS. 11 through 14 show flowcharts illustrating methods that support inter-message certificate and digest arrangements in wireless communications systems in accordance with aspects of the present disclosure.

### DETAILED DESCRIPTION

Some wireless communications systems may support cryptographic techniques for secure communications. For example, devices may use a public key infrastructure (PKI) or other techniques for verification of identities in the system. As an illustrative example, a transmitting device may transmit a message to a receiving device, and the message may indicate a certificate corresponding to the transmitting device. A receiving device may use such a certificate to verify an identity or authorization of the transmitting device. However, in some examples such systems may experience relatively high signaling overhead. For example, the transmitting device may transmit separate certificates for different types of messages or there may be relatively long durations between messages of a message type. In such cases, certificates may be communicated relatively often, which may result in poor resource utilization, inefficient communications, or both.

In accordance with the techniques described herein, wireless devices may implement inter-message certificate and digest arrangements in wireless communications systems. For example, the described techniques may enable devices to use certificates and digests across messages and message types in accordance with such inter-message certificate and digest arrangements. For example, a first wireless device may transmit a message including a certificate and subsequent messages including digests that correspond to the certificate. Digests may have a smaller payload size than a certificate (e.g., a digest may be a hash of the certificate). A receiving device may use a digest to identify the corresponding certificate. The receiving device may use the certificate to verify that the first wireless device is the authorized transmitter of each message. By communicating a message having a first message type to indicate a certificate, and then communicating one or more further messages having the same or different message type with a digest corresponding to the certificate, the system may realize improved communications efficiency, for example, while maintaining secure communications.

In some examples, the techniques described herein may support an anchor-based arrangement for inter-message certificates and digests. For example, a first wireless device (e.g., the transmitting device) may generate or determine a certificate associated with the first wireless device. For example, the certificate may be an example of a digital identity of the first wireless device or may otherwise identify the first wireless device (e.g., for PKI, the certificate may be used to prove that the first wireless device has ownership of a public key for the first wireless device). The first wireless device may generate or determine a digest corresponding to the certificate. For example, the digest may be generated based on the certificate (e.g., a device may apply a hash or other function to the certificate to obtain the digest having a smaller data size than the certificate). The first wireless device may include the certificate as part of a first message having a first message type. For example, the first message may be an anchor message, where the anchor message includes the certificate and subsequent messages include digests corresponding to the certificate. As such, an anchor message may refer to any message or message type that includes a certificate or other authorization feature to which subsequent messages refer or correspond to (e.g., using a digest or the like). For example, a particulate message type may be configured as an anchor message type, and the first transmitted message of that message type may be referred to as the anchor message. In some such examples, the first message is an anchor message and may be of a first message type. The subsequent messages may be of any message type (e.g., a message type different than the first message type) based on the first message being an anchor message. That is, the messages including digests may be of any message type and include digests corresponding to the certificate included in the anchor message that has the first message type.

Additionally or alternatively, the techniques described herein may support a timer-based arrangement. For example, the first wireless device may use a timer corresponding to a duration that a certificate is valid (e.g., the first wireless device may initiate the timer based on generating the certificate). Upon an expiration of the timer, the certificate may be invalid. Thus, the first wireless device may generate another certificate and restart the timer. In some examples, the first wireless device may transmit a message including the certificate after initiating or restarting the timer. For example, the earliest message of a set of messages communicated while the timer is active may include the certificate, and messages subsequent to the earliest message may include a respective digest corresponding to the certificate. In some examples, any message type may include the certificate (e.g., the earliest message may be of any message type). In some examples of the various techniques described herein, a wireless device may update an identifier periodically. In some cases, the wireless device may include a certificate in each message between updating the identifier and sending an anchor message of the anchor message type. Additionally or alternatively, the wireless device may restart a timer, and the first message subsequent to restarting the timer may include a certificate.

Aspects of the disclosure are initially described in the context of wireless communications systems. Aspects of the disclosure are further illustrated by and described with reference to transmission timelines and a process flow. Aspects of the disclosure are further illustrated by and described with reference to apparatus diagrams, system diagrams, and flowcharts that relate to inter-message certificate and digest arrangements in wireless communications systems.

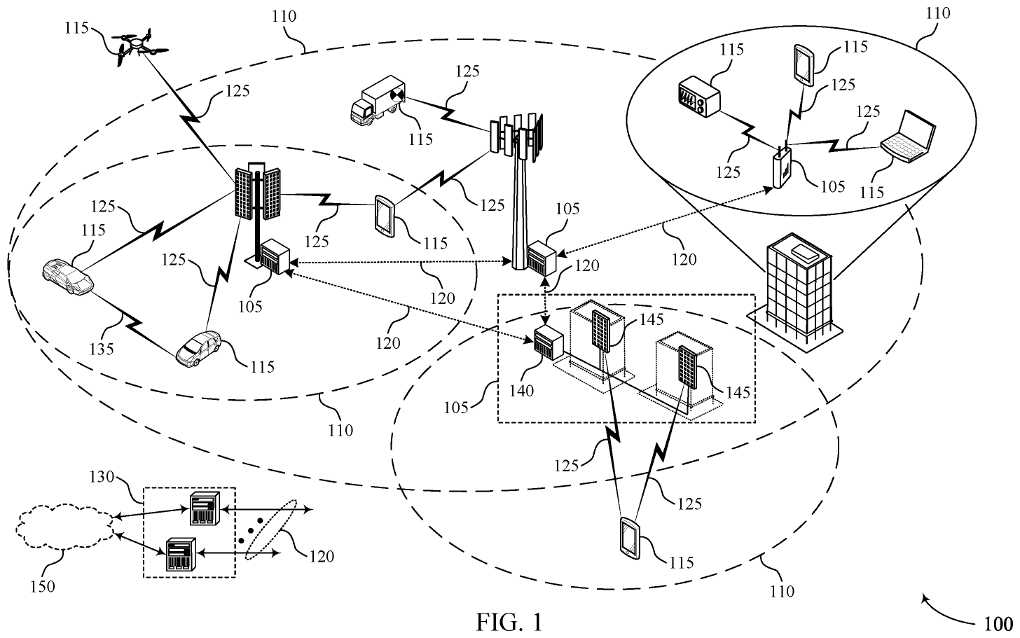

FIG. 1 illustrates an example of a wireless communications system 100 that supports inter-message certificate and digest arrangements in wireless communications systems in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the UE 115 may operate within a cellular-V2X (C-V2X) system. For example, the UE 115 may correspond to a vehicle, a UE 115 utilized by a pedestrian, one or more sensors within the C-V2X system, and the like. In some examples, the UE 115 may exchange messages with one or more other UEs 115 to enable safe vehicle operations in the presence of vulnerable road users (VRUs). In some examples, the UE 115 may securely exchange the aforementioned messages by utilizing one or more security measures (e.g., a PKI) to verify both transmissions and receptions corresponding to other UEs 115, where a PKI certificate may be used to verify an authorization of each C-V2X message.

In some cases, however, a signaling overhead associated with the PKI certificates may be large. For example, a basic safety message (BSM) payload without a corresponding certificate may have a data size, as an example, of 100-200 bytes. However, the certificate itself may have a relatively large data size, such as more than 100 bytes. In such cases, the overhead associated with the certificate may be relatively high due to including the certificate in the message payload (e.g., the payload of the BSM with the certificate may be nearly twice as large). To save signaling overhead and communication bandwidth, the UE 115 may implement a digest as an abbreviated version of the certificate (e.g., hash) or any other type of identifier or payload that indicates the certificate. A digest may be generated using one or more algorithms (e.g., a hashing algorithm) where the size of the digest may be relatively small (e.g., 8 bytes). In some BSM designs, when a vehicle (e.g., UE 115) receives a BSM with a full certificate, the vehicle may buffer the certificate in memory associated with the vehicle. If the vehicle receives subsequent BSMs with an associated digest, the vehicle may link the digest to the buffered certificate for signature inspection, which may decrease bandwidth and signaling overhead associated with certificates corresponding to messages within the C-V2X system (e.g., due to sending a digest as opposed to the certificate with each message).

In some cases, the use of a digest may be associated with an interval (e.g., an interval “vMaxCertDigestInterval”). As an illustrative example, the interval may be on the order of 450 milliseconds (ms). In such an example, a BSM transmission may be on the order of 100 ms, which may correspond to a first BSM carrying a full certificate, followed by four messages with a digest of the certificate. After expiration of the interval, a UE sending the BSM may need to include the full certificate again, after which the UE may send BSM messages with a digest for the remaining duration of the interval.

There may be many different types of messages in the wireless communications system 100 (e.g., a C-V2X system). A message type may refer to a message with a configured payload structure, purpose, periodicity, or other defining characteristic, and messages with different defining characteristics may be referred to as different message types. For example, a UE may utilize a BSM message type, a signal status message (SSM) message type, a vehicle incident report (VIR) message type, or any other number of message types. However, a UE may maintain a separate interval timer (e.g., vMaxCertDigestInterval timer) for each message type, which may be associated with one or more disadvantages. For example, within a single digest interval, a UE may send a full certificate with the first message of each message type. The overhead associated with transmitting separate certificates for multiple message types may increase as a quantity of message types increases. As another example, some event driven messages may be associated with long intervals, or are not periodic. For such messages, a full certificate may be attached during each message (e.g., due to a full interval elapsing before a subsequent message leveraging a digest may be sent). That is, a relatively high quantity of messages of such message types may include the certificate due to the relatively long intervals.

Due to the aforementioned disadvantages, there may be extraneous messages with full certificates sent for each message type, thus further enlarging message and resource size, while also increasing signaling overhead. For example, as discussed previously, a BSM may be transmitted every 100 ms over a 450 ms interval. Additionally, the BSM may be associated with a first certificate and a first digest. A SSM may also be transmitted every 100 ms over a 450 ms interval, where the SSM may be associated with a second certificate and a second digest. A third message (e.g., an event driven VIR), associated with a third certificate and third digest, may not be associated with an interval or may be periodically transmitted. In the aforementioned example, the BSM, the SSM, and the VIR may transmit a full certificate during a first time period, where the first time period may coincide with a first interval associated with the BSM and the SSM. In this example, the full certificates from the BSM, SSM, and VIR may consume bandwidth resources from the network and increase an overall signaling overhead. Additionally, while the BSM and SSM may utilize digests during the first interval, the VIR may transmit a full certificate during each transmission (e.g., due to the event driven nature of the VIR).

However, in some cases, a first wireless device (e.g., the UE 115) may transmit a single message of a first message type with a full certificate, where subsequent messages (e.g., of the same type, different types, or both) include digests that correspond to the full certificate. That is, a digest generated from a certificate included in a BSM may be utilized at a UE 115 or other device to identify the certificate for other message types (e.g., the device may be enabled to identify the certificate of the BSM using the digest of an SSM, as an illustrative example). For example, a full certificate associated with the BSM may be utilized or otherwise correspond to SSM and VIR message types as well as the BSM type, which may alleviate relatively frequently sending full certificates in all message types. By communicating a single message having a first message type to indicate a certificate, and then communicating further messages of any message type including a digest that corresponds to the certificate, overhead in the system from transmitting certificates may be reduced while maintaining secure communications, among other advantages.

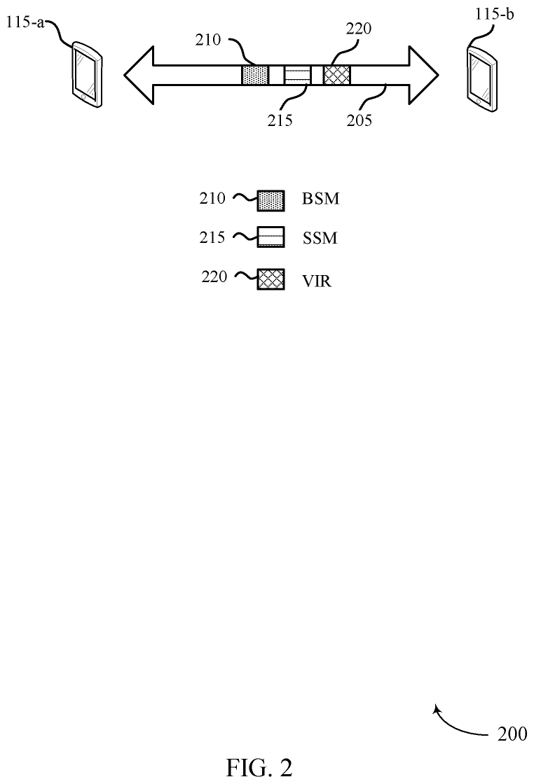

FIG. 2 illustrates an example of a wireless communications system 200 that supports inter-message certificate and digest arrangements in wireless communications systems in accordance with aspects of the present disclosure. The wireless communications system 200 may include a UE 115-a and a UE 115-b, which may be examples of a UE 115 as described with reference to FIG. 1. In some examples, the UE 115-a and UE 115-b may operate within a V2X system, a C-V2X system, or both, among other examples of wireless communications systems. While operations and techniques may be discussed below as being performed by particular wireless devices, it is to be understood that the operations and techniques may be performed by any number of wireless devices or type of wireless devices.

The UE 115-a and the UE 115-b may exchange messages of different types over a communication link 205. The communication link 205 may be an example of wireless communications links as described herein with reference to FIG. 1. For example, the communication link 205 may be a sidelink communications link (e.g., between devices in a C-V2X system) or another example of a communications link. In some cases, some messages may be periodic messages (e.g., BSM, SSM), while other messages may be event driven (e.g., VIR). The messages exchanged between the UE 115-a and the UE 115-b may be associated with a certificate, where the certificate may authenticate senders and receivers within the wireless communication system 200. For example, the UE 115-a (or another device in a PKI system) may generate a certificate associated with a set of messages to be transmitted to the UE 115-b. The UE 115-b may receive a first message from the UE 115-a, where the UE 115-b may examine the certificate associated with the set of messages to verify that the sender of the first message is indeed the UE 115-a. As an example, the identified certificate may map the UE 115-a to a public key and thus the UE 115-b may determine that the UE 115-a is authenticated by the PKI as the sender of the set of messages including a certificate or digests of the certificate.

In some examples, such as those described by the present disclosure, the UE 115-a and the UE 115-b may support techniques for utilizing certificate and digest mappings to reduce signaling overhead within the wireless communications system 200. For example, the UE 115-a and the UE 115-b may be configured or otherwise operable to communicate a certificate in a first message type and then use digests of the certificate when sending subsequent messages of any message type. Thus, the UE 115-a may refrain from sending certificates for each message type, improving a resource utilization and communications efficiency while the UE 115-b may successfully authenticate or identify the UE 115-a as the sender of the messages, which may result in secure communications.

For example, the BSM 210 may be an example of an anchor message (e.g., based on the UE 115-b and the UE 115-a implementing an anchor based arrangement), though any message type or message may be an example of an anchor message. The anchor message may be a message that includes the certificate and is the message to which subsequent messages of the same or different message type refer to. Other messages received after the BSM 210 may include digests linked or associated with the certificate (e.g., the digests may be hashes of the certificate). For example, the UE 115-b may verify that the UE 115-a is the sender of the messages using a certificate included in the BSM 210, a digest of the certificate included in the SSM 215, and the digest of certificate included in the VIR 220, or any combination thereof, though other message types and anchor message types are possible.

As an illustrative example, the UE 115-a may transmit an SSM 215 to the UE 115-b after transmitting the BSM 210 (e.g., within the interval that the certificate of the BSM 210 is valid or active), and the SSM 215 may include a digest of the certificate (e.g., instead of the full certificate that was transmitted with the BSM 210) The UE 115-b may receive the digest associated with the SSM 215 and map the digest to the certificate associated with the UE 115-a (e.g., the certificate included with the BSM 210). Similarly, the UE 115-b may receive a third message (e.g., a VIR 220) associated with a digest and verify and authenticate the sender (e.g., the UE 115-a) associated with the VIR 220 using the digest and the certificate of the anchor message (e.g., the BSM 210 in this example). Thus, the UE 115-b may perform authentication and authorization of the SSM 215 and the VIR 220 using associated digests instead of having to receive a full certificate for the SSM 215 and the VIR 220.

Additionally or alternatively to such an anchor based configuration, the UE 115-a and UE 115-b may utilize a timer-based configuration. For example, the UEs 115 may include a single timer associated with multiple message types, which may be an example of an interval timer as described herein (e.g., vMaxCertDigestInterval). In some examples, such a timer and/or duration of the timer may be preconfigured at the devices or may be configured via control signaling (e.g., via a base station 105, another UE 115, or other wireless devices). The timer may indicate a duration for which a certificate for multiple message types associated with the timer are valid. For example, whatever message that is first transmitted after the start of the timer or restart of the timer may carry a full certificate. Other messages transmitted during the time interval before the timer expires (e.g., after the first transmitted message) may carry digests that link to the first message, regardless of the type of message.

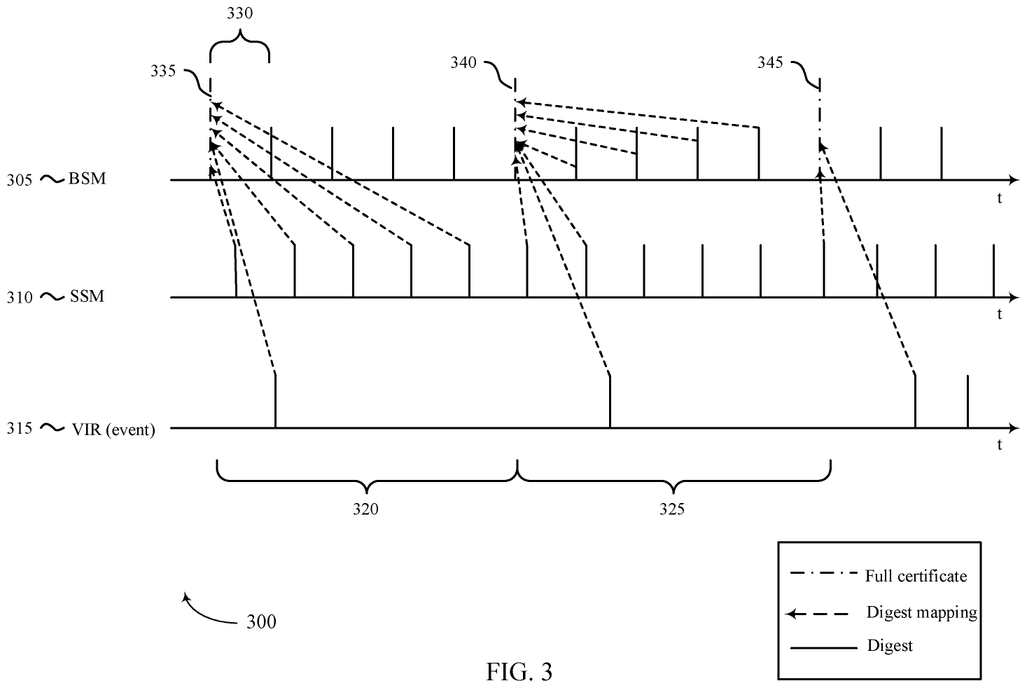

FIG. 3 illustrates an example of a transmission timeline 300 that supports inter-message certificate and digest arrangements in wireless communications systems in accordance with aspects of the present disclosure. The transmission timeline 300 may be utilized by one or more wireless devices, such as a base station 105-b and a UE 115-b, which may be examples of a base station 105 and a UE 115 as described with reference to FIG. 1. In some examples, the transmission timeline 300 may include one or more operations, signals, and procedures associated with one or more UEs which may be examples of those discussed with reference to FIG. 2. While specific operations and techniques are discussed below, the operations and techniques may be performed in a different order than the example order shown, or the operations performed by the devices may be performed by different devices or at different times.

In some examples, the transmission timeline 300 may illustrate an example of an anchor based arrangement as described herein, though it is to be understood that the transmission timeline 300 may include any message type or quantity of message types. In the examples of the transmission timelines described herein, a message on a respective timeline is shown via a line vertical to the time axis. For example, a dotted line may represent a message including a full certificate, a solid line may represent a message including a digest, and the dashed arrows may indicate which digests map to a respective full certificate of another message. In an anchor based arrangement, a particular message type (e.g., the BSM message type) may be configured as the anchor message, and the first message of that type transmitted in an interval may carry the full certificate, whereas subsequent messages transmitted in that interval, regardless of the message type, may only carry a digest of the certificate.

The BSM transmission timeline 305 may include a first BSM 335, which may be part of a set of messages associated with a certificate in the BSM 335. The other messages with digests in the first interval 320 may be included in the set of messages (e.g., the digest included in each of the messages in the first interval 320 may be a hash or otherwise map to the certificate of the BSM 335). In some examples, the BSM 335 may include the certificate and the associated digest. Additionally or alternatively, other devices in the system may generate the certificate and associated digest. For example, a receiving device may receive the certificate from the transmitting device or another device, the receiving device may generate the digest based on the certificate, the receiving device may receive the digest from the transmitting device or another device, etc.

Thus, a first UE (or another wireless device) may authenticate the identity of a sender of the messages in the various timelines using an anchor message on the BSM transmission timeline 305. For example, the first UE may authenticate subsequent BSMs (after receiving the BSM 335) received from the second UE during the first interval 320 using the digest. Additionally or alternatively, the first UE may use the certificate of the BSM 335 as an anchor for other types of messages received during the first interval 320. For example, the first UE may receive one or more SSMs and associated digests, which may correspond to the SSM transmission timeline 310 during the first interval 320. The first UE may identify the certificate of the BSM 335 based on the digests in the SSMs and authenticate the second UE as the sender UE based on the certificate and digests.

In other words, the first UE may receive SSMs, along with respective digests, after the BSM 335 and during the first interval 320. The first UE may utilize the certificate and digest arrangement associated with the BSM 335 and the digests associated with the SSMs to authenticate the sender (e.g., the second UE) of the SSMs, for example, without communicating full certificates within the SSMs. Additionally, the first UE may receive a VIR message, which may be associated with the VIR transmission timeline 315. In some examples, the VIR transmission timeline 315 may not be associated with a periodicity or interval. The first UE may utilize the certificate and digest arrangement, and the digest provided with the VIR message, to authenticate the sender of the VIR message, for example, without communicating full certificates in the VIR transmission timeline 315.

In some examples, the first interval 320 may expire (e.g., a timer with a duration that the certificate of the BSM 335 is valid may expire or restart or both). After the first interval 320, the first UE may receive a first message within the second interval 325 (e.g., the second interval 325 may be associated with a second certificate when a timer restarts). For example, the first UE may receive a BSM 340, along with an associated certificate and digest, during the second interval 325. The first UE may perform a similar procedure as those discussed above by utilizing the BSM 340 as an anchor for subsequent messages received after the BSM 340 within the second interval 325. The first UE may authenticate subsequent BSMs (after receiving the BSM 340) received from the second UE during the second interval 325 using the digest. Additionally or alternatively, the first UE may utilize the certificate and digest arrangement as an anchor for other types of messages received during the second interval 325 (e.g., SSMs during the second interval 325, VIR messages during the second interval 325, and so on).

The first UE may continue to utilize BSMs as anchors for subsequent intervals (e.g., BSM 345), where a certificate and digest arrangement associated with the BSM 345 may be used to authenticate other messages with digests during subsequent intervals. That is, the first UE may use digests for other messages received in a given time interval to point to the last BSM (e.g., or in some corner cases, point to the next BSM if no BSM was received before), which may reduce signaling overhead associated with V2X systems. In some other examples, the first UE may use other message types as the anchor message type. For example, if SSMs are the anchor type, the first SSM in an interval may be an anchor message including a full certificate, though other message types are possible. In some examples, the devices in the system may be pre-configured with the anchor message type or control signaling may indicate the anchor message type or both (e.g., devices may change an anchor message type using control signaling).

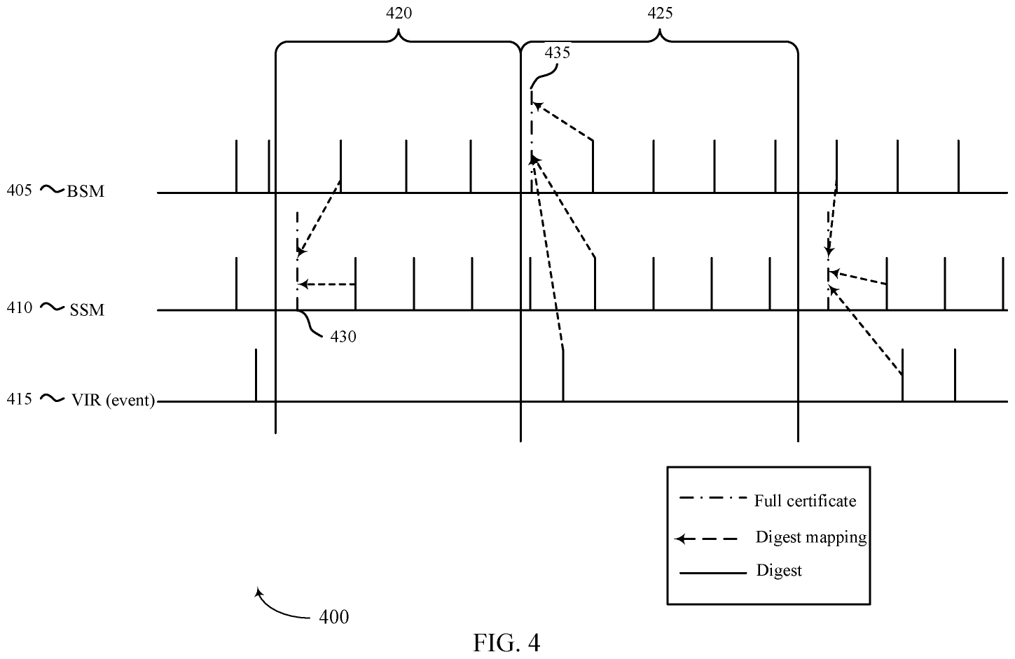

FIG. 4 illustrates an example of a transmission timeline 400 that supports inter-message certificate and digest arrangements in wireless communications systems in accordance with aspects of the present disclosure. The transmission timeline 400 may be performed by one or more wireless devices, such as a base station 105 and a UE 115, which may be examples of a base station 105 and a UE 115 as described with reference to FIG. 1. In some examples, the transmission timeline 400 may include one or more operations, signals, and procedures associated with one or more UEs, which may be examples of those discussed with reference to FIGS. 2 and 3. For example, the transmission timeline 400 may include aspects as described with reference to the transmission timeline 300. While specific operations and techniques are discussed below, the operations and techniques may be performed in a different order than the example order shown, or the operations performed by the devices may be performed by different devices or at different times.

In some examples, the transmission timeline 400 may illustrate an example of a timer based arrangement as described herein, though it is to be understood that the transmission timeline 400 may include any message type or quantity of message types. In the examples of the transmission timelines described herein, a message on a respective timeline is shown via a line vertical to the time axis. For example, a dotted line may represent a message including a full certificate, a solid line may represent a message including a digest, and the dashed arrows may indicate which digests map to a respective full certificate of another message.

One or more UEs may utilize a timer-based technique for leveraging a certificate and digest arrangement to authenticate a sender associated with different message types. In some examples, such as that illustrated by FIG. 4, a first UE may set or be configured with a timer (e.g., vMaxCertDigestInterval) for messages in the system. The timer may indicate a duration that a certificate for multiple message types is valid. For example, whatever message that is first transmitted (e.g., a first message) after a timer restarts (e.g., after an interval begins) may carry a full certificate, for example, regardless of the type of the first transmitted message. Other messages transmitted during the interval may carry digests that link to the first message.

For example, the first UE may receive an SSM 430 associated with an SSM transmission timeline 410. The SSM 430 received at the first UE may correspond to a first message received during a time interval 420. As such, the SSM 430 may carry a full certificate authenticating a sender device (e.g., a second UE), where the first UE may utilize the SSM 430 as a reference to authenticate other messages received from the second UE during the time interval 420. For example, the first UE may receive a BSM with a digest from the second UE within the time interval 420 as shown in the BSM transmission timeline 405. In such cases, the first UE may utilize the digest associated with the BSM and the SSM 430 to authenticate the sender of the BSM while reducing signaling overhead associated with authentication within the system.

The first UE may continue to receive BSM or other messages of other message types, along with associated digests, where the first UE may continue to authenticate the sender of the other messages as the second UE using the SSM 430 within the time interval 420. However, once the time interval has elapsed, the first UE may receive a first message (e.g., a BSM 435) within a second time interval 425. For example, the first UE may receive a BSM 435 from the second UE at the beginning of the second time interval 425 after restarting a timer. As such, the BSM 435 may carry a full certificate authenticating the second UE, and the first UE may utilize the certificate of the BSM 435 to authenticate other messages received from the second UE during the second time interval 425 that have digests linked to the certificate.

For example, the first UE may receive an SSM with a digest from the second UE within the second time interval 425. In such cases, the first UE may utilize the digest associated with the SSM to identify the certificate of the BSM 435 and authenticate the sender of the SSM. Additionally, the second UE may receive a VIR and a digest associated with a VIR transmission timeline 415 during the second time interval 425. The first UE may utilize the digest associated with the VIR to authenticate the sender of the VIR. Such techniques may enable the first UE to reduce the signaling overhead associated with transmitting a certificate for each message type and the processing overhead of maintaining separate timers for each message type, among other benefits.

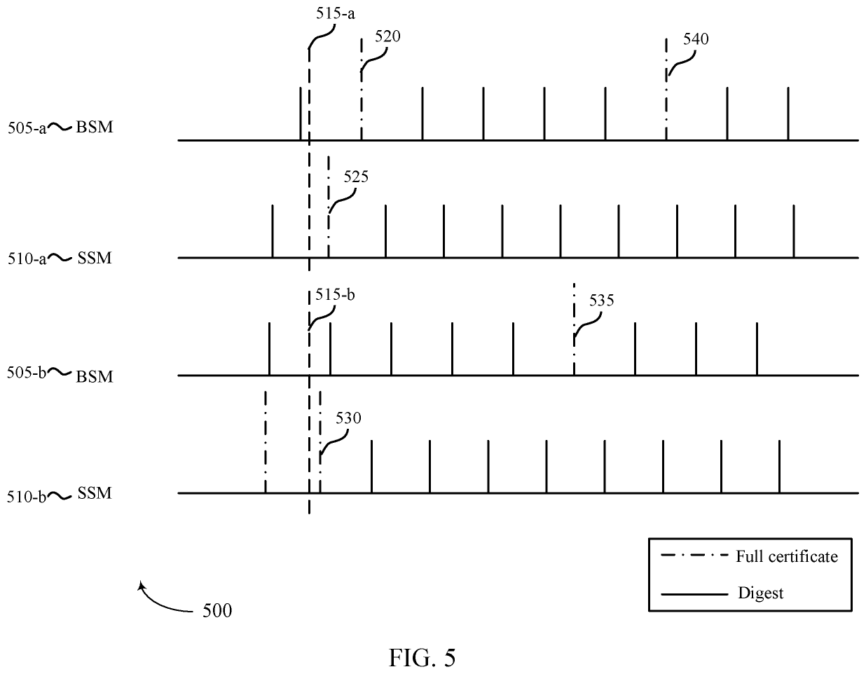

FIG. 5 illustrates an example of a transmission timeline 500 that supports inter-message certificate and digest arrangements in wireless communications systems in accordance with aspects of the present disclosure. The transmission timeline 500 may be performed by one or more wireless devices, such as a UE, which may be examples of a UE 115 as described with reference to FIG. 1. In some examples, the transmission timeline 500 may include one or more operations, signals, and procedures associated with the UE or another device, which may be examples of those discussed with reference to FIGS. 2-4. While specific operations and techniques are discussed below, the operations and techniques may be performed in a different order than the example order shown, or the operations performed by the devices may be performed by different devices or at different times.

In some examples, the transmission timeline 500 may illustrate examples of operations for ID changes for the various arrangements as described herein, though it is to be understood that the transmission timeline 500 may include any message type or quantity of message types. In the examples of the transmission timelines described herein, a message on a respective timeline is shown via a line vertical to the time axis. For example, a dotted line may represent a message including a full certificate, a solid line may represent a message including a digest, and the dashed arrows may indicate which digests map to a respective full certificate of another message. In some examples, the BSM timeline 505-a and the SSM timeline 510-a may illustrate an example of an ID change for anchor based arrangements and the BSM timeline 505-b and SSM timeline 510-b may illustrate an example of an ID change for timer based arrangements. Further, though described below as a UE or a vehicle, it is to be understood that any wireless device implementing the techniques described herein may be used.

In some cases, such as in V2X systems, a vehicle (e.g., a UE) may change a source L2 ID (or similar ID that can identify a sender) associated with the vehicle to protect privacy associated with a user, though any identifier may be used. In some examples, a receiver (e.g., a UE 115 or other wireless device) may utilize the L2 source ID (e.g., or a similar ID that can identify a sender) of different messages to identify what messages are transmitted from the same sender and correlate them together. For example, messages may include a field indicating the L2 source ID and the UE may identify which messages are linked as being from the device with the L2 source ID.

In some cases, a vehicle may change the source L2 ID after an interval (e.g., vCertChangeInterval with a duration of, for example, 300 ms). When the vehicle's source L2 ID is changed, other vehicles may not be able to leverage a certificate and digest mapping to link new messages to old messages received from the vehicle after the L2 ID is changed (e.g., since a new L2 ID may generate or correspond to a different certificate and digest arrangement).

Accordingly, the devices may implement techniques to enable other devices to successfully authenticate messages after an ID change 515. For example, after an ID change 515-a, messages received between the ID change 515-a and a first BSM (e.g., BSM 520) may carry a full certificate. By including the full certificate for each message having a non-anchor message type in the interim between the ID change 515-a (which invalidates a certificate of a previous anchor message) and a new anchor message, devices may successfully authenticate the messages before a new anchor message is received. In some examples, since BSM (or another message type acting as an anchor message type) may be sent relatively often (e.g., every 100 ms), additional signaling overhead associated with waiting for the first BSM may be relatively low.

As another illustrative example, a BSM transmission timeline 505-b and an SSM transmission timeline 510-b may be associated with a timer-based arrangement. A first message to be sent after an ID change 515-b may carry a full certificate. Additionally or alternatively, once the first message is sent, a new timer may start (e.g., vMaxCertDigestInterval). That is, the timer indicating the duration for which the old certificate of an interval prior to the ID change 515-b may be restarted and a new interval may be initiated. For example, since the SSM 530 may be the earliest message received after the ID change 515-b (e.g., the SSM 530 may be the first message received after the timer is restarted), the first UE may utilize the certificate of the SSM 530 to authenticate subsequent messages from the second UE carrying digests.

In some examples, the timer may expire. In such examples, the first UE may receive a first message within a duration of a subsequent interval of the timer, where the first UE may utilize the certificate of the earliest message within the subsequent interval to authenticate future messages (e.g., with associated digests) sent from the second UE.

Table 1 below shows an example of a BSM for illustrative clarity, though any fields may be included in the message type.

TABLE 1
protocolVersion

| content | signedData | hashId | | | |
|---|---|---|---|---|---|
| | | tbsData | payload | data | protocolVersion |
| | | | | | content |

| | |
|---|---|
| | extDataHash |
| headerInfo | aid |
| | generationTime |
| | expiryTime |
| | generationLocation |
| | p2pcdLearningRequest |
| | missingCrlIdentifier |
| | encryptionKey |
| | inlineP2pcdRequest |
| | requestedCertificate |
| | pduFunctionalType |

| | |
|---|---|
| signer | digest |
| | certificate |
| | self |
| | x509 |
| signature | sm2Signature |

In Table 1, the message includes a field for a digest or a certificate, though other locations or options for indicating the digest or certificate in a message or through other signaling is possible.

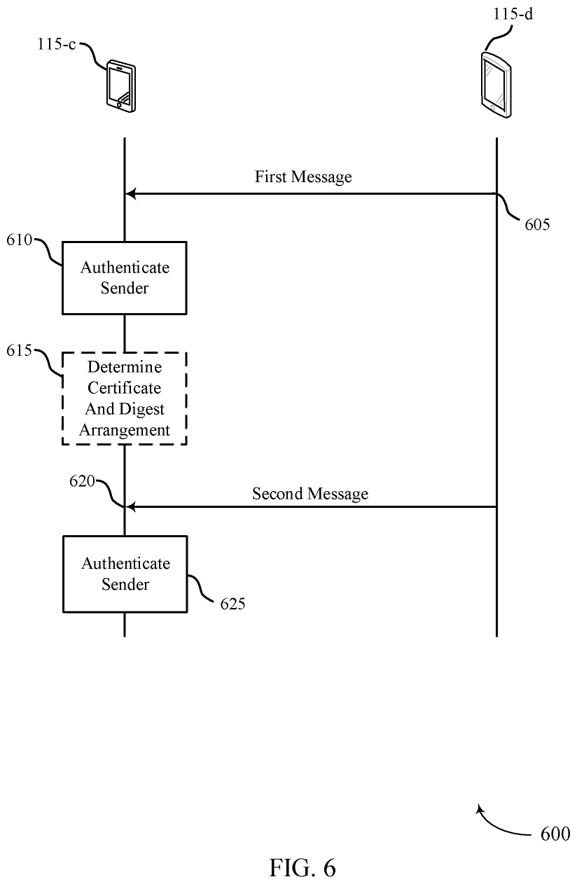

FIG. 6 illustrates an example of a process flow 600 that supports inter-message certificate and digest arrangement in wireless communications systems in accordance with aspects of the present disclosure. The process flow 600 may be performed by one or more wireless devices, such as a UE 115-c and a UE 115-d, which may be examples of a UE 115 as described with reference to FIG. 1. In some examples, the process flow 600 may include one or more operations, signals, and procedures associated with the UEs 115-c and 115-d, which may be examples of those discussed with reference to FIGS. 2-5. While specific operations and techniques are discussed below, the operations and techniques may be performed in a different order than the example order shown, or the operations performed by the devices may be performed by different devices or at different times. For example, while described as UEs 115, it is to be understood that any devices may be used in the process flow 600.

At 605, the UE 115-d may transmit the first message to the UE 115-c. The first message may include a respective certificate (e.g., a PKI certificate). In some examples, the UE 115-d may determine that a data packet (e.g., the first message) is awaiting transmission to the UE 115-c. The UE 115-d may generate or otherwise identify the certificate in accordance with the techniques described herein. The first message may include the certificate based on being an anchor message or an earliest message after the initiation of restarting of a timer or interval, or based on being a message subsequent to an ID change.

At 610, the UE 115-c may authenticate the sender of the first message as the UE 115-d. For example, the UE 115-c may receive the first message having the first message type (e.g., BSM, SSM, VIR, or any other message type) and use the certificate to authenticate the ID of the sender.

In some examples, at 615 the UE 115-c may determine a certificate and digest arrangement. For example, the UE 115-c may be pre-configured with the arrangement or control signaling may indicate or configure the UE 115-c with the arrangement. In some examples, the arrangement includes a timer based arrangement or an anchor based arrangement as described herein. For example, the UE 115-c may utilize the certificate and digest arrangement to authenticate subsequent messages from the UE 115-d based on a time interval, a timer, an anchor, an updated L2 ID, or some combination thereof. At 620, the UE 115-d may transmit a second message to the UE 115-c (e.g., a second BSM, VIR, SSM), where the second message carries a digest associated with the UE 115-d. In some examples, the second message may have a message type different than the first message. That is, the certificate of the first message having the first message type may correspond to multiple message types including the second message type. Thus, the second message may include a digest that corresponds to or is linked with the certificate of the first message (e.g., the digest may be a hash of the certificate).

At 625, the UE 115-c may authenticate the sender of the second message (e.g., the UE 115-d). For example, the UE 115-c may identify the certificate buffered in memory after receiving the first message based on the digest of the second message. The UE 115-c may thus identify the sender of the second message as the UE 115-d.

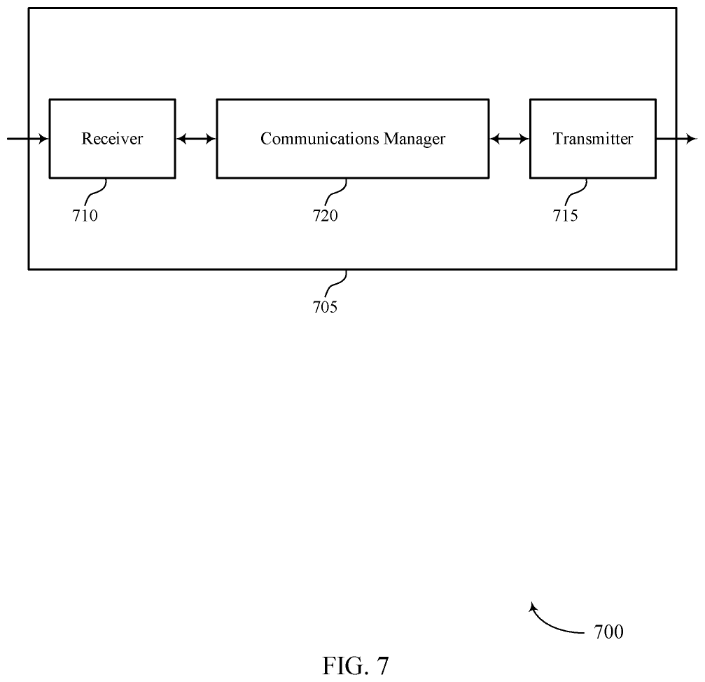

FIG. 7 shows a block diagram 700 of a device 705 that supports inter-message certificate and digest arrangements in wireless communications systems in accordance with aspects of the present disclosure. The device 705 may be an example of aspects of a UE 115 or other wireless device as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to inter-message certificate and digest arrangements in wireless communications systems). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to inter-message certificate and digest arrangements in wireless communications systems). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of inter-message certificate and digest arrangements in wireless communications systems as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a first wireless device in accordance with examples as disclosed herein. For example, the communications manager 720 may be configured as or otherwise support a means for generating, by the first wireless device, a certificate for authentication of a set of messages and a digest corresponding to the certificate. The communications manager 720 may be configured as or otherwise support a means for transmitting a first message of the set of messages to a second wireless device, the first message having a first message type and including the certificate. The communications manager 720 may be configured as or otherwise support a means for transmitting a second message of the set of messages to the second wireless device, the second message having a second message type different than the first message type, where the second message includes the digest corresponding to the certificate of the first message.

Additionally or alternatively, the communications manager 720 may support wireless communication at a second wireless device in accordance with examples as disclosed herein. For example, the communications manager 720 may be configured as or otherwise support a means for receiving a first message of a set of messages from a first wireless device, the first message having a first message type and including a certificate for authentication of the set of messages. The communications manager 720 may be configured as or otherwise support a means for receiving a second message of the set of messages from the first wireless device, the second message having a second message type different than the first message type, where the second message includes a digest corresponding to the certificate of the first message having the first message type. The communications manager 720 may be configured as or otherwise support a means for authenticating the identity of the first wireless device as the transmitter of the set of messages based on the digest and the certificate.

By including or configuring the communications manager 720 in accordance with examples as described herein, the device 705 (e.g., a processor controlling or otherwise coupled to the receiver 710, the transmitter 715, the communications manager 720, or a combination thereof) may support techniques for reduced processing power and reduced computational complexity by decreasing payload sizes associated with authenticating senders of messages within a wireless communications system.

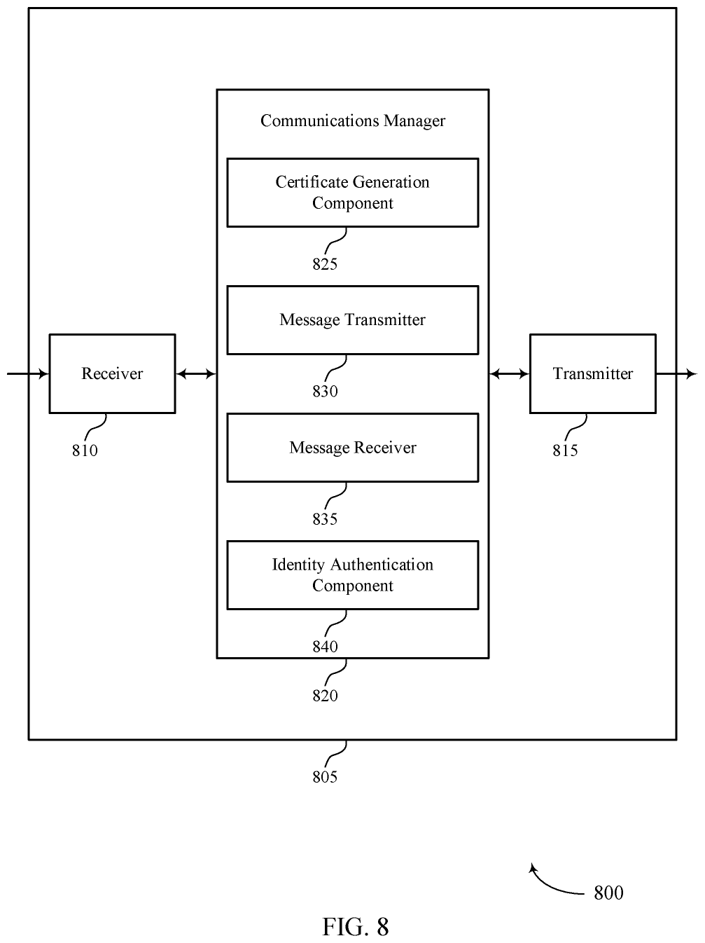

FIG. 8 shows a block diagram 800 of a device 805 that supports inter-message certificate and digest arrangements in wireless communications systems in accordance with aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to inter-message certificate and digest arrangements in wireless communications systems). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to inter-message certificate and digest arrangements in wireless communications systems). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of inter-message certificate and digest arrangements in wireless communications systems as described herein. For example, the communications manager 820 may include a certificate generation component 825, a message transmitter 830, a message receiver 835, an identity authentication component 840, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a first wireless device in accordance with examples as disclosed herein. The certificate generation component 825 may be configured as or otherwise support a means for generating, by the first wireless device, a certificate for authentication of a set of messages and a digest corresponding to the certificate. The message transmitter 830 may be configured as or otherwise support a means for transmitting a first message of the set of messages to a second wireless device, the first message having a first message type and including the certificate. The message transmitter 830 may be configured as or otherwise support a means for transmitting a second message of the set of messages to the second wireless device, the second message having a second message type different than the first message type, where the second message includes the digest corresponding to the certificate of the first message.

Additionally or alternatively, the communications manager 820 may support wireless communication at a second wireless device in accordance with examples as disclosed herein. The message receiver 835 may be configured as or otherwise support a means for receiving a first message of a set of messages from a first wireless device, the first message having a first message type and including a certificate for authentication of the set of messages. The message receiver 835 may be configured as or otherwise support a means for receiving a second message of the set of messages from the first wireless device, the second message having a second message type different than the first message type, where the second message includes a digest corresponding to the certificate of the first message having the first message type. The identity authentication component 840 may be configured as or otherwise support a means for authenticating the identity of the first wireless device as the transmitter of the set of messages based on the digest and the certificate.

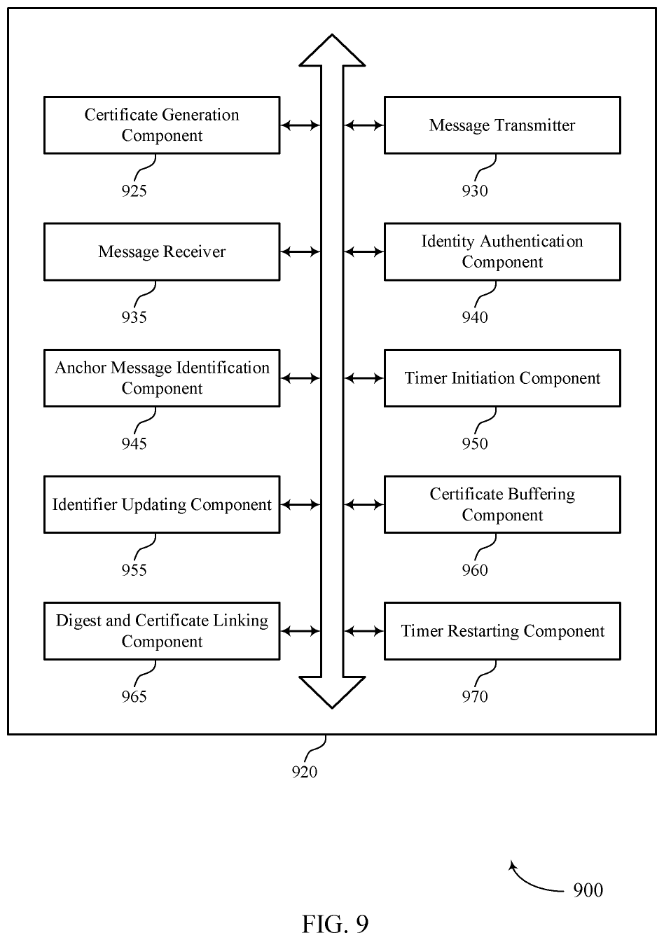

FIG. 9 shows a block diagram 900 of a communications manager 920 that supports inter-message certificate and digest arrangements in wireless communications systems in accordance with aspects of the present disclosure. The communications manager 920 may be an example of aspects of a communications manager 720, a communications manager 820, or both, as described herein. The communications manager 920, or various components thereof, may be an example of means for performing various aspects of inter-message certificate and digest arrangements in wireless communications systems as described herein. For example, the communications manager 920 may include a certificate generation component 925, a message transmitter 930, a message receiver 935, an identity authentication component 940, an anchor message identification component 945, a timer initiation component 950, an identifier updating component 955, a certificate buffering component 960, a digest and certificate linking component 965, a timer restarting component 970, or any combination thereof. Each of these components may communicate, directly or indirectly, with one another (e.g., via one or more buses).

The communications manager 920 may support wireless communication at a first wireless device in accordance with examples as disclosed herein. The certificate generation component 925 may be configured as or otherwise support a means for generating, by the first wireless device, a certificate for authentication of a set of messages and a digest corresponding to the certificate. The message transmitter 930 may be configured as or otherwise support a means for transmitting a first message of the set of messages to a second wireless device, the first message having a first message type and including the certificate. In some examples, the message transmitter 930 may be configured as or otherwise support a means for transmitting a second message of the set of messages to the second wireless device, the second message having a second message type different than the first message type, where the second message includes the digest corresponding to the certificate of the first message.

In some examples, the anchor message identification component 945 may be configured as or otherwise support a means for identifying the first message as an anchor message of the set of messages based on a configuration of the first wireless device indicating that the anchor message corresponds to the first message type, where transmitting the first message including the certificate is based on the identifying.

In some examples, the certificate generation component 925 may be configured as or otherwise support a means for generating, subsequent to communicating the set of messages, a second certificate for authentication of a second set of messages and a second digest corresponding to the second certificate. In some examples, the message transmitter 930 may be configured as or otherwise support a means for transmitting a third message as a second anchor message of the second set of messages based on the third message having the first message type, the third message including the second certificate. In some examples, the message transmitter 930 may be configured as or otherwise support a means for transmitting a fourth message of the second set of messages, the fourth message including the second digest corresponding to the second certificate.

In some examples, the timer initiation component 950 may be configured as or otherwise support a means for initiating a timer associated with a duration that the certificate, the digest, or both are valid, where transmitting the first message including the certificate is based on initiating the timer.

In some examples, the first message is an earliest message of the set of messages subsequent to initiating the timer.

In some examples, the certificate generation component 925 may be configured as or otherwise support a means for generating a second certificate for authentication of a second set of messages and a second digest corresponding to the second certificate based on restarting the timer. In some examples, the message transmitter 930 may be configured as or otherwise support a means for transmitting a third message of the second set of messages, the third message including the second certificate based on the third message being an earliest message of the second set of messages, where the third message includes the first message type or the second message type. In some examples, the message transmitter 930 may be configured as or otherwise support a means for transmitting a fourth message including the second digest corresponding to the second certificate.

In some examples, the message transmitter 930 may be configured as or otherwise support a means for transmitting a third message having a third message type to the second wireless device, the third message including the digest corresponding to the certificate of the first message having the first message type.

In some examples, the message transmitter 930 may be configured as or otherwise support a means for transmitting an indication of an identifier of the first wireless device to at least the second wireless device, where transmitting the first message, the second message, or both is based on the indication of the identifier.

In some examples, the identifier updating component 955 may be configured as or otherwise support a means for updating an identifier of the first wireless device based on an expiration of a timer associated with a duration that the identifier is valid. In some examples, the message transmitter 930 may be configured as or otherwise support a means for transmitting a third message including a second certificate based on updating the identifier.

In some examples, to support wireless communications, the message transmitter 930 may be configured as or otherwise support a means for transmitting, in a duration between updating the identifier and transmitting the third message, one or more messages having different message types than the first message type associated with the anchor message, each of the one or more messages including the second certificate. In some examples, to support wireless communications, the message transmitter 930 may be configured as or otherwise support a means for transmitting a fourth message subsequent to the third message, the fourth message including a second digest corresponding to the second certificate.

In some examples, the timer restarting component 970 may be configured as or otherwise support a means for restarting a timer associated with a duration that the certificate, the digest, or both are valid based on updating the identifier, where transmitting the third message is based on restarting the timer.

In some examples, the third message includes an earliest message of a second set of messages associated with the second certificate, the third message having the first message type or the second message type. In some examples, the certificate has a first data size larger than a second data size of the digest. In some examples, the digest includes a hash of the certificate. In some examples, the certificate is associated with a set of multiple message types including the first message type and the second message type.

Additionally or alternatively, the communications manager 920 may support wireless communication at a second wireless device in accordance with examples as disclosed herein. The message receiver 935 may be configured as or otherwise support a means for receiving a first message of a set of messages from a first wireless device, the first message having a first message type and including a certificate for authentication of the set of messages. In some examples, the message receiver 935 may be configured as or otherwise support a means for receiving a second message of the set of messages from the first wireless device, the second message having a second message type different than the first message type, where the second message includes a digest corresponding to the certificate of the first message having the first message type. The identity authentication component 940 may be configured as or otherwise support a means for authenticating the identity of the first wireless device as the transmitter of the set of messages based on the digest and the certificate.

In some examples, to support authenticating the identity of the first wireless device, the certificate buffering component 960 may be configured as or otherwise support a means for buffering the certificate in a memory of the second wireless device based on receiving the first message. In some examples, to support authenticating the identity of the first wireless device, the digest and certificate linking component 965 may be configured as or otherwise support a means for linking the digest of the second message to the certificate of the first message.

In some examples, the message receiver 935 may be configured as or otherwise support a means for receiving a third message having a third message type from the first wireless device, the third message including the digest corresponding to the certificate of the first message having the first message type. In some examples, the identity authentication component 940 may be configured as or otherwise support a means for authenticating the first wireless device as the transmitter of the third message based on the digest of the third message and the certificate of the first message.

In some examples, the message receiver 935 may be configured as or otherwise support a means for receiving a third message including a second certificate for authentication of a second set of message, the third message having any message type of a set of multiple message types. In some examples, the message receiver 935 may be configured as or otherwise support a means for receiving a fourth message including a second digest corresponding to the second certificate, the fourth message having any message type of the set of multiple message types. In some examples, the identity authentication component 940 may be configured as or otherwise support a means for authenticating the identity of the first wireless device as the transmitter of the third message and the fourth message based on the second certificate and the second digest.

In some examples, the message receiver 935 may be configured as or otherwise support a means for receiving an indication of an identifier of the first wireless device, where authenticating the identity of the first wireless device as the transmitter of the set of messages is based on the indication of the identifier. In some examples, the certificate has a first data size larger than a second data size of the digest. In some examples, the digest includes a hash of the certificate. In some examples, the certificate is associated with a set of multiple message types including the first message type and the second message type.

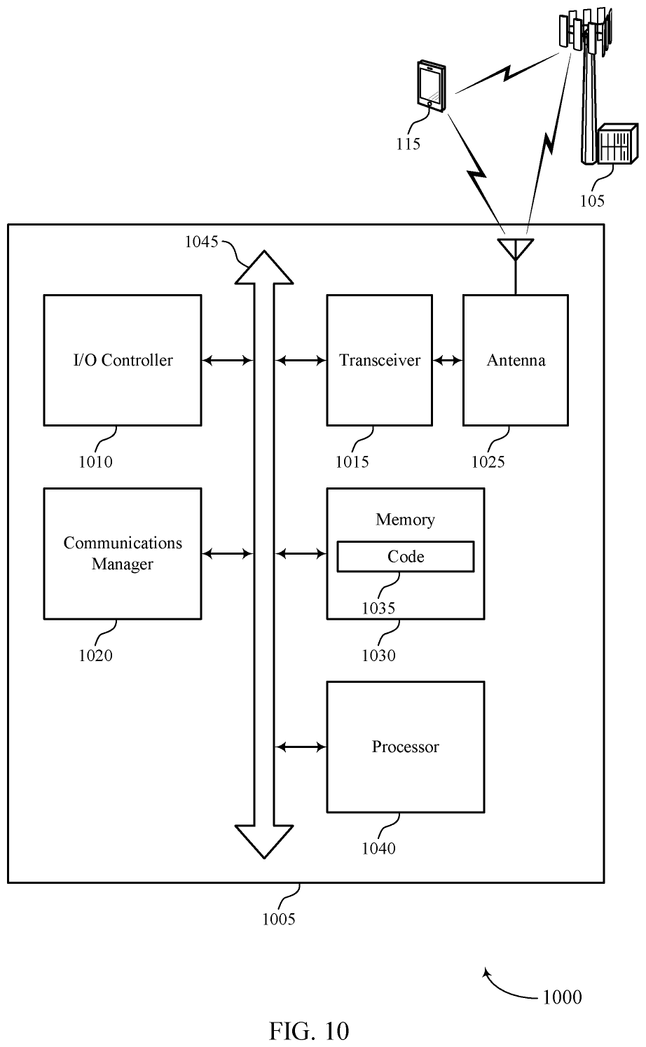

FIG. 10 shows a diagram of a system 1000 including a device 1005 that supports inter-message certificate and digest arrangements in wireless communications systems in accordance with aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting inter-message certificate and digest arrangements in wireless communications systems). For example, the device 1005 or a component of the device 1005 may include a processor 1040 and memory 1030 coupled to the processor 1040, the processor 1040 and memory 1030 configured to perform various functions described herein.

The communications manager 1020 may support wireless communication at a first wireless device in accordance with examples as disclosed herein. For example, the communications manager 1020 may be configured as or otherwise support a means for generating, by the first wireless device, a certificate for authentication of a set of messages and a digest corresponding to the certificate. The communications manager 1020 may be configured as or otherwise support a means for transmitting a first message of the set of messages to a second wireless device, the first message having a first message type and including the certificate. The communications manager 1020 may be configured as or otherwise support a means for transmitting a second message of the set of messages to the second wireless device, the second message having a second message type different than the first message type, where the second message includes the digest corresponding to the certificate of the first message.

Additionally or alternatively, the communications manager 1020 may support wireless communication at a second wireless device in accordance with examples as disclosed herein. For example, the communications manager 1020 may be configured as or otherwise support a means for receiving a first message of a set of messages from a first wireless device, the first message having a first message type and including a certificate for authentication of the set of messages. The communications manager 1020 may be configured as or otherwise support a means for receiving a second message of the set of messages from the first wireless device, the second message having a second message type different than the first message type, where the second message includes a digest corresponding to the certificate of the first message having the first message type. The communications manager 1020 may be configured as or otherwise support a means for authenticating the identity of the first wireless device as the transmitter of the set of messages based on the digest and the certificate.

By including or configuring the communications manager 1020 in accordance with examples as described herein, the device 1005 may support techniques for reducing signaling overhead in a wireless communications system associated with transmitting certificates while maintaining secure communications

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of inter-message certificate and digest arrangements in wireless communications systems as described herein, or the processor 1040 and the memory 1030 may be otherwise configured to perform or support such operations.

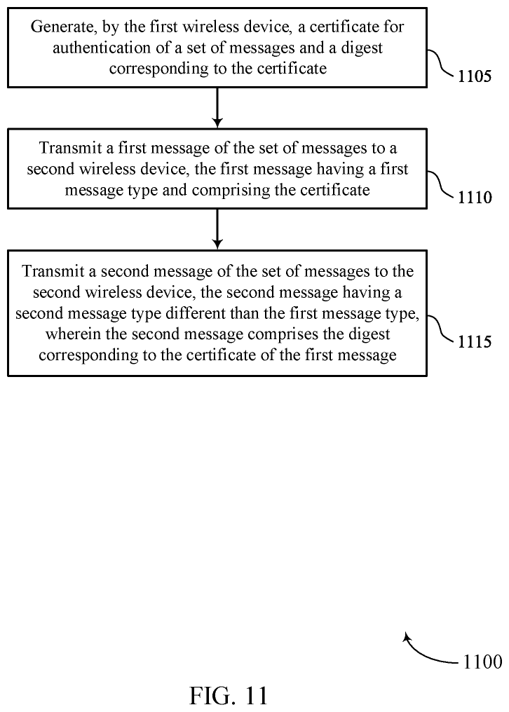

FIG. 11 shows a flowchart illustrating a method 1100 that supports inter-message certificate and digest arrangements in wireless communications systems in accordance with aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1105, the method may include generating, by the first wireless device, a certificate for authentication of a set of messages and a digest corresponding to the certificate. The operations of 1105 may be performed in accordance with examples as disclosed herein. In some examples, aspects of the operations of 1105 may be performed by a certificate generation component 925 as described with reference to FIG. 9.

At 1110, the method may include transmitting a first message of the set of messages to a second wireless device, the first message having a first message type and including the certificate. The operations of 1110 may be performed in accordance with examples as disclosed herein. In some examples, aspects of the operations of 1110 may be performed by a message transmitter 930 as described with reference to FIG. 9.

At 1115, the method may include transmitting a second message of the set of messages to the second wireless device, the second message having a second message type different than the first message type, where the second message includes the digest corresponding to the certificate of the first message. The operations of 1115 may be performed in accordance with examples as disclosed herein. In some examples, aspects of the operations of 1115 may be performed by a message transmitter 930 as described with reference to FIG. 9.

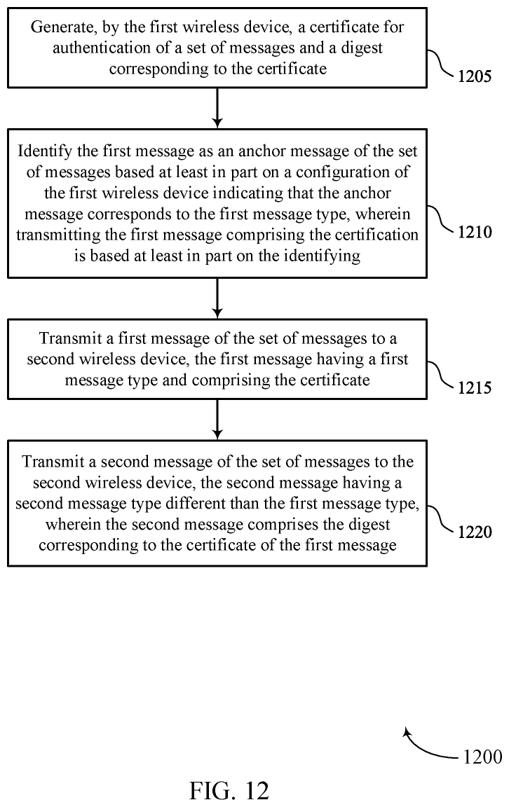

FIG. 12 shows a flowchart illustrating a method 1200 that supports inter-message certificate and digest arrangements in wireless communications systems in accordance with aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1205, the method may include generating, by the first wireless device, a certificate for authentication of a set of messages and a digest corresponding to the certificate. The operations of 1205 may be performed in accordance with examples as disclosed herein. In some examples, aspects of the operations of 1205 may be performed by a certificate generation component 925 as described with reference to FIG. 9.

At 1210, the method may include identifying the first message as an anchor message of the set of messages based on a configuration of the first wireless device indicating that the anchor message corresponds to the first message type, where transmitting the first message including the certificate is based on the identifying. The operations of 1210 may be performed in accordance with examples as disclosed herein. In some examples, aspects of the operations of 1210 may be performed by an anchor message identification component 945 as described with reference to FIG. 9.

At 1215, the method may include transmitting a first message of the set of messages to a second wireless device, the first message having a first message type and including the certificate. The operations of 1215 may be performed in accordance with examples as disclosed herein. In some examples, aspects of the operations of 1215 may be performed by a message transmitter 930 as described with reference to FIG. 9.

At 1220, the method may include transmitting a second message of the set of messages to the second wireless device, the second message having a second message type different than the first message type, where the second message includes the digest corresponding to the certificate of the first message. The operations of 1220 may be performed in accordance with examples as disclosed herein. In some examples, aspects of the operations of 1220 may be performed by a message transmitter 930 as described with reference to FIG. 9.

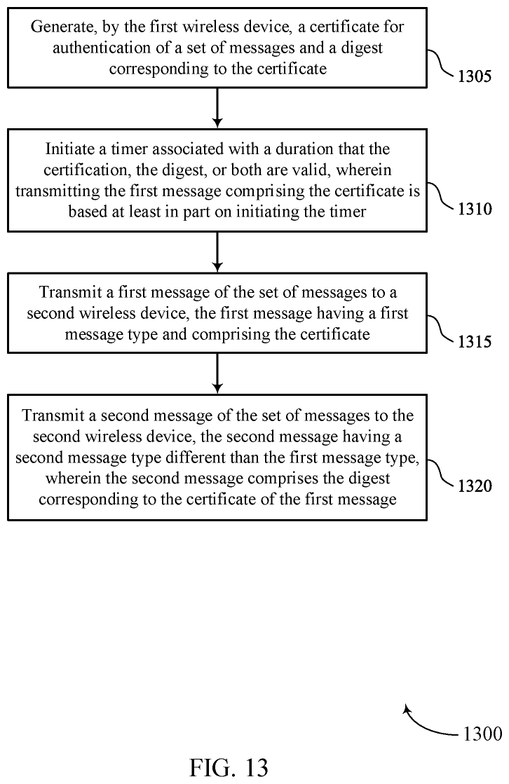

FIG. 13 shows a flowchart illustrating a method 1300 that supports inter-message certificate and digest arrangements in wireless communications systems in accordance with aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1305, the method may include generating, by the first wireless device, a certificate for authentication of a set of messages and a digest corresponding to the certificate. The operations of 1305 may be performed in accordance with examples as disclosed herein. In some examples, aspects of the operations of 1305 may be performed by a certificate generation component 925 as described with reference to FIG. 9.

At 1310, the method may include initiating a timer associated with a duration that the certificate, the digest, or both are valid, where transmitting the first message including the certificate is based on initiating the timer. The operations of 1310 may be performed in accordance with examples as disclosed herein. In some examples, aspects of the operations of 1310 may be performed by a timer initiation component 950 as described with reference to FIG. 9.

At 1315, the method may include transmitting a first message of the set of messages to a second wireless device, the first message having a first message type and including the certificate. The operations of 1315 may be performed in accordance with examples as disclosed herein. In some examples, aspects of the operations of 1315 may be performed by a message transmitter 930 as described with reference to FIG. 9.

At 1320, the method may include transmitting a second message of the set of messages to the second wireless device, the second message having a second message type different than the first message type, where the second message includes the digest corresponding to the certificate of the first message. The operations of 1320 may be performed in accordance with examples as disclosed herein. In some examples, aspects of the operations of 1320 may be performed by a message transmitter 930 as described with reference to FIG. 9.

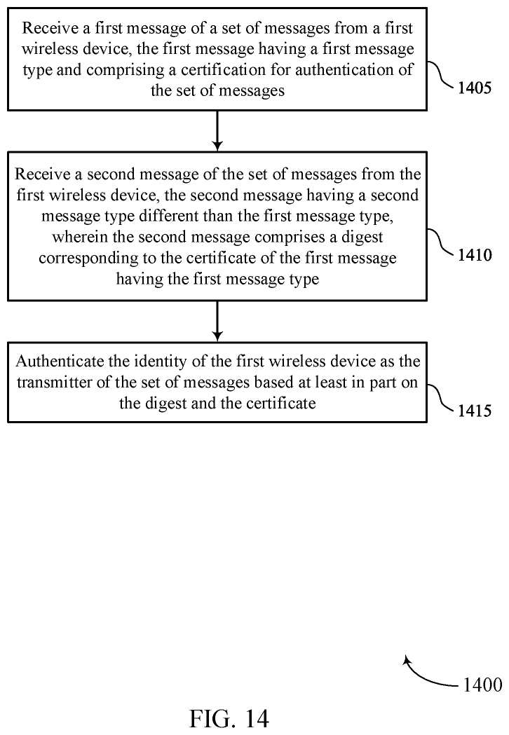

FIG. 14 shows a flowchart illustrating a method 1400 that supports inter-message certificate and digest arrangements in wireless communications systems in accordance with aspects of the present disclosure. The operations of the method 1400 may be implemented by a UE or its components as described herein. For example, the operations of the method 1400 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1405, the method may include receiving a first message of a set of messages from a first wireless device, the first message having a first message type and including a certificate for authentication of the set of messages. The operations of 1405 may be performed in accordance with examples as disclosed herein. In some examples, aspects of the operations of 1405 may be performed by a message receiver 935 as described with reference to FIG. 9.

At 1410, the method may include receiving a second message of the set of messages from the first wireless device, the second message having a second message type different than the first message type, where the second message includes a digest corresponding to the certificate of the first message having the first message type. The operations of 1410 may be performed in accordance with examples as disclosed herein. In some examples, aspects of the operations of 1410 may be performed by a message receiver 935 as described with reference to FIG. 9.

At 1415, the method may include authenticating the identity of the first wireless device as the transmitter of the set of messages based on the digest and the certificate. The operations of 1415 may be performed in accordance with examples as disclosed herein. In some examples, aspects of the operations of 1415 may be performed by an identity authentication component 940 as described with reference to FIG. 9.

The following provides an overview of aspects of the present disclosure:

Aspect 1: A method for wireless communication at a first wireless device, comprising: generating, by the first wireless device, a certificate for authentication of a set of messages and a digest corresponding to the certificate; transmitting a first message of the set of messages to a second wireless device, the first message having a first message type and comprising the certificate; and transmitting a second message of the set of messages to the second wireless device, the second message having a second message type different than the first message type, wherein the second message comprises the digest corresponding to the certificate of the first message.

Aspect 2: The method of aspect 1, further comprising: identifying the first message as an anchor message of the set of messages based at least in part on a configuration of the first wireless device indicating that the anchor message corresponds to the first message type, wherein transmitting the first message comprising the certification is based at least in part on the identifying.

Aspect 3: The method of aspect 2, further comprising: generating, subsequent to communicating the set of messages, a second certificate for authentication of a second set of messages and a second digest corresponding to the second certificate; transmitting a third message as a second anchor message of the second set of messages based at least in part on the third message having the first message type, the third message comprising the second certificate; and transmitting a fourth message of the second set of messages, the fourth message comprising the second digest corresponding to the second certificate.

Aspect 4: The method of any of aspects 1 through 3, further comprising: initiating a timer associated with a duration that the certification, the digest, or both are valid, wherein transmitting the first message comprising the certificate is based at least in part on initiating the timer.

Aspect 5: The method of aspect 4, wherein the first message is an earliest message of the set of messages subsequent to initiating the timer.

Aspect 6: The method of any of aspects 4 through 5, further comprising: generating a second certificate for authentication of a second set of messages and a second digest corresponding to the second certificate based at least in part on restarting the timer; transmitting a third message of the second set of messages, the third message comprising the second certificate based at least in part on the third message being an earliest message of the second set of messages, wherein the third message comprises the first message type or the second message type; and transmitting a fourth message comprising the second digest corresponding to the second certificate.

Aspect 7: The method of any of aspects 1 through 6, further comprising: transmitting a third message having a third message type to the second wireless device, the third message comprising the digest corresponding to the certificate of the first message having the first message type.

Aspect 8: The method of any of aspects 1 through 7, further comprising: transmitting an indication of an identifier of the first wireless device to at least the second wireless device, wherein transmitting the first message, the second message, or both is based at least in part on the indication of the identifier.

Aspect 9: The method of any of aspects 1 through 8, further comprising: updating an identifier of the first wireless device based at least in part on an expiration of a timer associated with a duration that the identifier is valid; and transmitting a third message comprising a second certificate based at least in part on updating the identifier.

Aspect 10: The method of aspect 9, wherein the third message comprises an anchor message, further comprising: transmitting, in a duration between updating the identifier and transmitting the third message, one or more messages having different message types than the first message type associated with the anchor message, each of the one or more messages comprising the second certificate; and transmitting a fourth message subsequent to the third message, the fourth message comprising a second digest corresponding to the second certificate.

Aspect 11: The method of any of aspects 9 through 10, further comprising: restarting a timer associated with a duration that the certification, the digest, or both are valid based at least in part on updating the identifier, wherein transmitting the third message is based at least in part on restarting the timer.

Aspect 12: The method of aspect 11, wherein the third message comprises an earliest message of a second set of messages associated with the second certificate, the third message having the first message type or the second message type.

Aspect 13: The method of any of aspects 1 through 12, wherein the certificate has a first data size larger than a second data size of the digest.

Aspect 14: The method of aspect 13, wherein the digest comprises a hash of the certificate.

Aspect 15: The method of any of aspects 1 through 14, wherein the certificate is associated with a plurality of message types comprising the first message type and the second message type.

Aspect 16: A method for wireless communication at a second wireless device, comprising: receiving a first message of a set of messages from a first wireless device, the first message having a first message type and comprising a certification for authentication of the set of messages; receiving a second message of the set of messages from the first wireless device, the second message having a second message type different than the first message type, wherein the second message comprises a digest corresponding to the certificate of the first message having the first message type; and authenticating the identity of the first wireless device as the transmitter of the set of messages based at least in part on the digest and the certificate.

Aspect 17: The method of aspect 16, wherein authenticating the identity of the first wireless device comprises: buffering the certificate in a memory of the second wireless device based at least in part on receiving the first message; and linking the digest of the second message to the certificate of the first message.

Aspect 18: The method of any of aspects 16 through 17, further comprising: receiving a third message having a third message type from the first wireless device, the third message comprising the digest corresponding to the certificate of the first message having the first message type; and authenticating the first wireless device as the transmitter of the third message based at least in part on the digest of the third message and the certificate of the first message.

Aspect 19: The method of any of aspects 16 through 18, further comprising: receiving a third message comprising a second certificate for authentication of a second set of message, the third message having any message type of a plurality of message types; receiving a fourth message comprising a second digest corresponding to the second certificate, the fourth message having any message type of the plurality of message types; and authenticating the identity of the first wireless device as the transmitter of the third message and the fourth message based at least in part on the second certificate and the second digest.

Aspect 20: The method of any of aspects 16 through 19, further comprising: receiving an indication of an identifier of the first wireless device, wherein authenticating the identity of the first wireless device as the transmitter of the set of messages is based at least in part on the indication of the identifier.

Aspect 21: The method of any of aspects 16 through 20, wherein the certificate has a first data size larger than a second data size of the digest.

Aspect 22: The method of aspect 21, wherein the digest comprises a hash of the certificate.

Aspect 23: The method of any of aspects 16 through 22, wherein the certificate is associated with a plurality of message types comprising the first message type and the second message type.

Aspect 24: An apparatus for wireless communication at a first wireless device, comprising a processor; memory coupled with the processor; and instructions stored in the memory and executable by the processor to cause the apparatus to perform a method of any of aspects 1 through 15.

Aspect 25: An apparatus for wireless communication at a first wireless device, comprising at least one means for performing a method of any of aspects 1 through 15.

Aspect 26: A non-transitory computer-readable medium storing code for wireless communication at a first wireless device, the code comprising instructions executable by a processor to perform a method of any of aspects 1 through 15.

Aspect 27: An apparatus for wireless communication at a second wireless device, comprising a processor; memory coupled with the processor; and instructions stored in the memory and executable by the processor to cause the apparatus to perform a method of any of aspects 16 through 23.

Aspect 28: An apparatus for wireless communication at a second wireless device, comprising at least one means for performing a method of any of aspects 16 through 23.

Aspect 29: A non-transitory computer-readable medium storing code for wireless communication at a second wireless device, the code comprising instructions executable by a processor to perform a method of any of aspects 16 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first wireless device, comprising:
generating, by the first wireless device, a certificate for authentication of a set of messages and a digest corresponding to the certificate;
transmitting a first message of the set of messages to a second wireless device, the first message having a first message type and comprising the certificate; and
transmitting a second message of the set of messages to the second wireless device, the second message having a second message type different than the first message type, wherein the second message comprises the digest corresponding to the certificate of the first message.

2. The method of claim 1, further comprising:
identifying the first message as an anchor message of the set of messages based at least in part on a configuration of the first wireless device indicating that the anchor message corresponds to the first message type, wherein transmitting the first message comprising the certificate is based at least in part on the identifying.

3. The method of claim 2, further comprising:
generating, subsequent to communicating the set of messages, a second certificate for authentication of a second set of messages and a second digest corresponding to the second certificate;
transmitting a third message as a second anchor message of the second set of messages based at least in part on the third message having the first message type, the third message comprising the second certificate; and
transmitting a fourth message of the second set of messages, the fourth message comprising the second digest corresponding to the second certificate.

4. The method of claim 1, further comprising:
initiating a timer associated with a duration that the certificate, the digest, or both are valid, wherein transmitting the first message comprising the certificate is based at least in part on initiating the timer.

5. The method of claim 4, wherein the first message is an earliest message of the set of messages subsequent to initiating the timer.

6. The method of claim 4, further comprising:
generating a second certificate for authentication of a second set of messages and a second digest corresponding to the second certificate based at least in part on restarting the timer;
transmitting a third message of the second set of messages, the third message comprising the second certificate based at least in part on the third message being an earliest message of the second set of messages, wherein the third message comprises the first message type or the second message type; and
transmitting a fourth message comprising the second digest corresponding to the second certificate.

7. The method of claim 1, further comprising:
transmitting a third message having a third message type to the second wireless device, the third message comprising the digest corresponding to the certificate of the first message having the first message type.

8. The method of claim 1, further comprising:
transmitting an indication of an identifier of the first wireless device to at least the second wireless device, wherein transmitting the first message, the second message, or both is based at least in part on the indication of the identifier.

9. The method of claim 1, further comprising:
updating an identifier of the first wireless device based at least in part on an expiration of a timer associated with a duration that the identifier is valid; and
transmitting a third message comprising a second certificate based at least in part on updating the identifier.

10. The method of claim 9, wherein the third message comprises an anchor message, further comprising:
transmitting, in a duration between updating the identifier and transmitting the third message, one or more messages having different message types than the first message type associated with the anchor message, each of the one or more messages comprising the second certificate; and
transmitting a fourth message subsequent to the third message, the fourth message comprising a second digest corresponding to the second certificate.

11. The method of claim 9, further comprising:
restarting a timer associated with a duration that the certificate, the digest, or both are valid based at least in part on updating the identifier, wherein transmitting the third message is based at least in part on restarting the timer.

12. The method of claim 11, wherein the third message comprises an earliest message of a second set of messages associated with the second certificate, the third message having the first message type or the second message type.

13. The method of claim 1, wherein the certificate has a first data size larger than a second data size of the digest.

14. The method of claim 13, wherein the digest comprises a hash of the certificate.

15. The method of claim 1, wherein the certificate is associated with a plurality of message types comprising the first message type and the second message type.

16. A method for wireless communication at a second wireless device, comprising:
receiving a first message of a set of messages from a first wireless device, the first message having a first message type and comprising a certificate for authentication of the set of messages;
receiving a second message of the set of messages from the first wireless device, the second message having a second message type different than the first message type, wherein the second message comprises a digest corresponding to the certificate of the first message having the first message type; and
authenticating an identity of the first wireless device as a transmitter of the set of messages based at least in part on the digest and the certificate.

17. The method of claim 16, wherein authenticating the identity of the first wireless device comprises:
buffering the certificate in a memory of the second wireless device based at least in part on receiving the first message; and
linking the digest of the second message to the certificate of the first message.

18. The method of claim 16, further comprising:
receiving a third message having a third message type from the first wireless device, the third message comprising the digest corresponding to the certificate of the first message having the first message type; and
authenticating the first wireless device as the transmitter of the third message based at least in part on the digest of the third message and the certificate of the first message.

19. The method of claim 16, further comprising:
receiving a third message comprising a second certificate for authentication of a second set of message, the third message having any message type of a plurality of message types;
receiving a fourth message comprising a second digest corresponding to the second certificate, the fourth message having any message type of the plurality of message types; and
authenticating the identity of the first wireless device as the transmitter of the third message and the fourth message based at least in part on the second certificate and the second digest.

20. The method of claim 16, further comprising:
receiving an indication of an identifier of the first wireless device, wherein authenticating the identity of the first wireless device as the transmitter of the set of messages is based at least in part on the indication of the identifier.

21. The method of claim 16, wherein the certificate has a first data size larger than a second data size of the digest.

22. The method of claim 21, wherein the digest comprises a hash of the certificate.

23. The method of claim 16, wherein the certificate is associated with a plurality of message types comprising the first message type and the second message type.

24. An apparatus for wireless communication at a first wireless device, comprising:
a processor;
memory coupled with the processor; and
instructions stored in the memory and executable by the processor to cause the apparatus to:
generate, by the first wireless device, a certificate for authentication of a set of messages and a digest corresponding to the certificate;
transmit a first message of the set of messages to a second wireless device, the first message having a first message type and comprising the certificate; and
transmit a second message of the set of messages to the second wireless device, the second message having a second message type different than the first message type, wherein the second message comprises the digest corresponding to the certificate of the first message.

25. The apparatus of claim 24, wherein the instructions are further executable by the processor to cause the apparatus to:
identify the first message as an anchor message of the set of messages based at least in part on a configuration of the first wireless device indicating that the anchor message corresponds to the first message type, wherein transmitting the first message comprising the certificate is based at least in part on the identifying.

26. The apparatus of claim 25, wherein the instructions are further executable by the processor to cause the apparatus to:
generate, subsequent to communicating the set of messages, a second certificate for authentication of a second set of messages and a second digest corresponding to the second certificate;
transmit a third message as a second anchor message of the second set of messages based at least in part on the third message having the first message type, the third message comprising the second certificate; and
transmit a fourth message of the second set of messages, the fourth message comprising the second digest corresponding to the second certificate.

27. The apparatus of claim 24, wherein the instructions are further executable by the processor to cause the apparatus to:
initiate a timer associated with a duration that the certificate, the digest, or both are valid, wherein transmitting the first message comprising the certificate is based at least in part on initiating the timer.

28. The apparatus of claim 27, wherein the first message is an earliest message of the set of messages subsequent to initiating the timer.

29. The apparatus of claim 27, wherein the instructions are further executable by the processor to cause the apparatus to:
generate a second certificate for authentication of a second set of messages and a second digest corresponding to the second certificate based at least in part on restarting the timer;
transmit a third message of the second set of messages, the third message comprising the second certificate based at least in part on the third message being an earliest message of the second set of messages, wherein the third message comprises the first message type or the second message type; and
transmit a fourth message comprising the second digest corresponding to the second certificate.

30. An apparatus for wireless communication at a second wireless device, comprising:
a processor;
memory coupled with the processor; and
instructions stored in the memory and executable by the processor to cause the apparatus to:
receive a first message of a set of messages from a first wireless device, the first message having a first message type and comprising a certificate for authentication of the set of messages;
receive a second message of the set of messages from the first wireless device, the second message having a second message type different than the first message type, wherein the second message comprises a digest corresponding to the certificate of the first message having the first message type; and
authenticate an identity of the first wireless device as a transmitter of the set of messages based at least in part on the digest and the certificate.
